(19) United States
(12) Patent Application Publication
(10) Pub. No.: US 2026/0230672 A1
(43) Pub. Date: Aug. 6, 2026

(54) ELECTRONIC DEVICE AND METHOD FOR PROVIDING VIDEO CONTENT THEREOF

(71) Applicant: Samsung Electronics Co., Ltd., Suwon-si (KR)

(72) Inventors: Nagyeom YOO, Suwon-si (KR); Sungkweon PARK, Suwon-si (KR); Jaeyung YEO, Suwon-si (KR); Yongjoon JEON, Suwon-si (KR)

(21) Appl. No.: 19/636,508

(22) Filed: Apr. 1, 2026

Related U.S. Application Data
(63) Continuation of application No. PCT/KR2024/013284, filed on Sep. 4, 2024.

(30) Foreign Application Priority Data
Oct. 27, 2023 (KR) 10-2023-0146075
Nov. 14, 2023 (KR) 10-2023-0157318

(51) Int. Cl. H04N 21/44; H04N 21/4223; H04N 21/458; H04N 21/8547

(52) U.S. Cl. CPC H04N 21/44016; H04N 21/4223; H04N 21/458; H04N 21/8547

(57) ABSTRACT

An electronic device is provided. The electronic device includes at least one processor, and memory storing instructions that, when executed by the at least one processor individually or collectively, cause the electronic device to determine, respectively, a first state of a user and a second state of the user, based on one or more of a property of first video content and first sensor data acquired while the first video content is being output, output second video content including second image frames temporally positioned between first image frames of the first video content, based on a difference between the first state and the second state, and output third video content including fourth image frames temporally positioned after a third image frame of the first video content, based on second sensor data acquired after the output of the second video content is initiated.

### CROSS-REFERENCE TO RELATED APPLICATION(S

This application is a continuation application, claiming priority under 35 U.S.C. § 365(c), of an International application No. PCT/KR2024/013284, filed on September 4, 2024, which is based on and claims the benefit of a Korean patent application number 10-2023-0146075, filed on October 27, 2023, in the Korean Intellectual Property Office, and of a Korean patent application number 10-2023-0157318, filed on November 14, 2023, in the Korean Intellectual Property Office, the disclosure of each of which is incorporated by reference herein in its entirety.

### BACKGROUND

### 1. Field

The disclosure relates to an electronic device and a method for providing video content thereof.

### 2. Description of Related Art

Personalized content may provide tailored content to a user based on preferences, interests, behaviors, and states of the user.

In the video content field, techniques such as capturing a user and synthesizing a user image to specific image frames of original video content are being used.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a technology for analyzing the state of a user watching video content in real time and providing personalized video content based on the user state and the characteristics of the video content may be required.

Additional aspects will be set forth in part in the description which follows and, in part, will be apparent from the description, or may be learned by practice of the presented embodiments.

In accordance with an aspect of the disclosure, an electronic device is provided. The electronic device includes at least one processor, and memory storing instructions that, when executed by the at least one processor individually or collectively, cause the electronic device to determine, respectively, a first state of a user and a second state of the user, based on one or more of a property of first video content and first sensor data acquired while the first video content is being output, output second video content including second image frames temporally positioned between first image frames of the first video content, based on a difference between the first state and the second state, and output third video content including fourth image frames temporally positioned after a third image frame of the first video content, based on second sensor data acquired after the output of the second video content is initiated.

In accordance with another aspect of the disclosure, a method of operating an electronic device is provided. The method includes determining, respectively, a first state of a user and a second state of the user, based on one or more of a property of first video content and first sensor data acquired while the first video content is being output, outputting second video content including second image frames temporally positioned between first image frames of the first video content, based on a difference between the first state and the second state, and outputting third video content including fourth image frames temporally positioned after a third image frame of the first video content, based on second sensor data acquired after the output of the second video content is initiated.

In accordance with another aspect of the disclosure, an electronic device is provided. The electronic device includes at least one processor. The electronic device includes memory storing instructions. The instructions, when executed by the at least one processor individually or collectively, cause the electronic device to determine, respectively, a current state of a user and a target state of the user, based on one or more of a property of first video content and sensor data acquired while the first video content is being output. The instructions, when executed by the at least one processor individually or collectively, cause the electronic device to generate second video content based on a difference between the current state and the target state. The instructions, when executed by the at least one processor individually or collectively, cause the electronic device to output the second video content after a reference image frame of the first video content, which may be determined based on an amount of time required for generating the second video content.

In accordance with another aspect of the disclosure, one or more non-transitory computer-readable storage media storing one or more computer programs including computer-executable instructions at, when executed by one or more processors of an apparatus individually or collectively, cause the apparatus to perform the method on a processor is provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a diagram illustrating an operation for determining a state of a user according to an embodiment of the disclosure;

FIG. 3 is a diagram illustrating an operation of providing personalized video content according to an embodiment of the disclosure;

FIGS. 4 and 5 are diagrams illustrating a method of generating personalized video content according to various embodiments of the disclosure;

FIG. 6 is a diagram illustrating the difference between first personalized video content and second personalized video content according to an embodiment of the disclosure;

FIG. 7 is a diagram illustrating an operation of determining an output timepoint of personalized video content according to an embodiment of the disclosure;

FIG. 8 is a diagram illustrating a method of setting a section of video content according to an embodiment of the disclosure;

FIG. 9 is a diagram illustrating an operation of determining an output timepoint of personalized video content according to an embodiment of the disclosure;

FIG. 10 is a diagram illustrating an operation of determining a user state according to an embodiment of the disclosure;

FIG. 11 is a schematic block diagram of a system for generating personalized content according to an embodiment of the disclosure;

FIG. 12 is a diagram illustrating an example of a situation in which personalized content is provided, according to an embodiment of the disclosure; and

FIG. 13 is a flowchart illustrating an operation of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

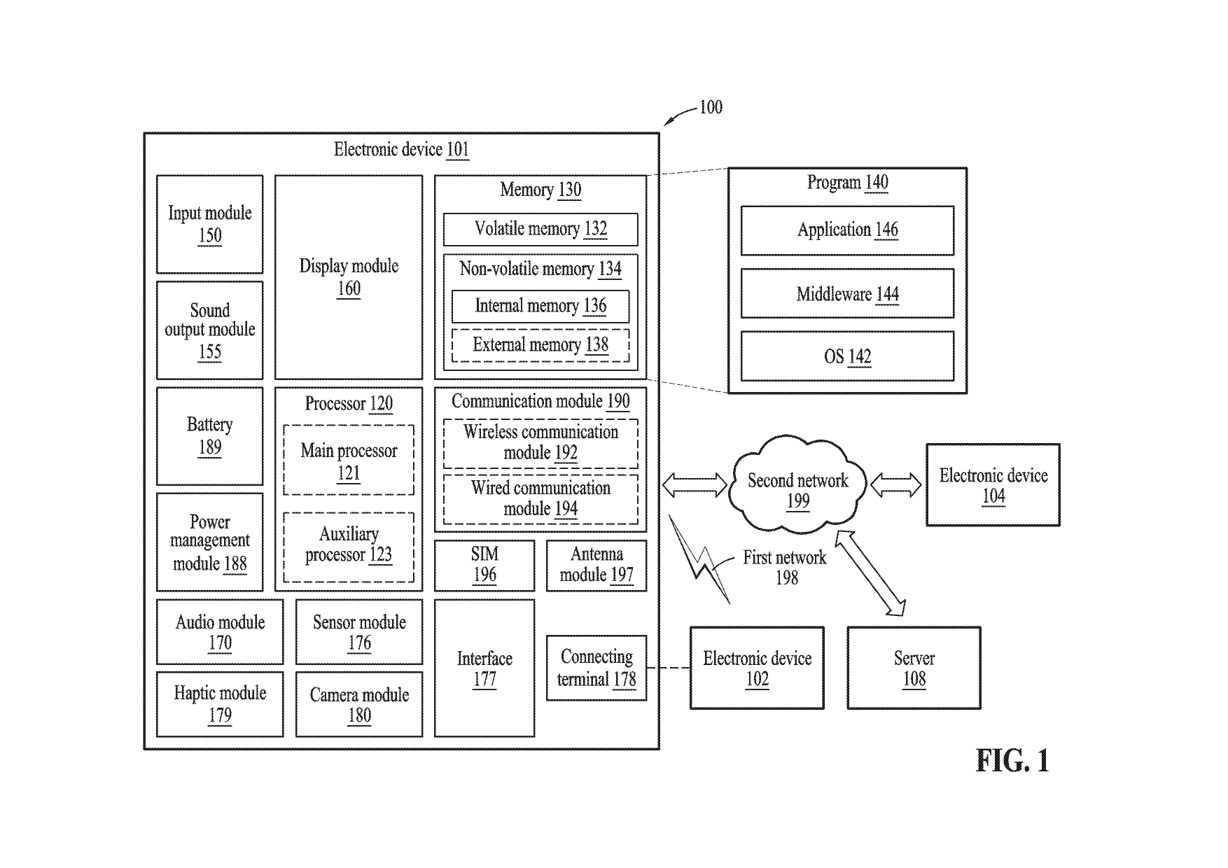

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134.

According to an embodiment, the processor 120 may be implemented as circuitry (e.g., processing circuitry) such as a system on chip (SoC) or integrated circuit (IC). The processor 120 may include one or more processors. For example, the processor 120 may include a combination of one or more processors such as a central processing unit (CPU), a graphics processing unit (GPU), a micro processing unit (MPU), an application processor (AP), and a communication processor (CP).

According to an embodiment, the processor 120 may include a main processor 121 (e.g., a CPU or an AP) or an auxiliary processor 123 (e.g., a GPU, a neural processing unit (NPU), an image signal processor (ISP), a sensor hub processor, or a CP) that is operable independently of, or in conjunction with the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., an NPU) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

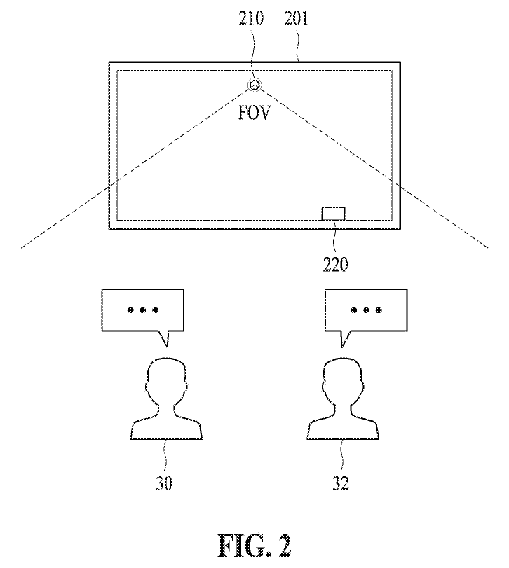

According to an embodiment, the memory 130 may include one or more memories. Instructions stored in the memory 130 may be stored in a single memory. The instructions stored in the memory 130 may be divided and stored in a plurality of memories. The instructions stored in the memory 130 may be individually or collectively executed by the processor 120 to cause the electronic device 101 (e.g., an electronic device 201 of FIG. 2) to perform and/or control a method of providing video content described with reference to FIGS. 2 to 13. The instructions stored in the memory 130 may be individually or collectively executed by a plurality of processors to cause the electronic device 101 (e.g., the electronic device 201 of FIG. 2) to perform and/or control the method of providing video content described with reference to FIGS. 2 to 13. According to an embodiment, the memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing a recording. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150 or output the sound via the sound output module 155 or an external electronic device (e.g., the electronic device 102 such as a speaker or headphones) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected with an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as, or a different type, from the electronic device 101. According to an embodiment, all or some of operations to be executed by the electronic device 101 may be executed at one or more of the external electronic devices 102 or 104 or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

FIG. 2 is a diagram illustrating an operation for determining a state of a user according to an embodiment of the disclosure.

Referring to FIG. 2, according to an embodiment, an electronic device 201 (e.g., the electronic device 101 of FIG. 1) may output video content (e.g., an online course video, a movie).

According to an embodiment, the electronic device 201 may acquire sensor data related to a user using sensors (e.g., the sensor module 176 of FIG. 1) while the video content is being output. For example, the electronic device 201 may use a camera sensor 210 (e.g., the camera module 180 of FIG. 1) to acquire an image of one or more users 30 and 32 within a field of view (FOV) of the camera sensor 210. In another example, the electronic device 201 may acquire audio data including a voice of the one or more users 30 and 32 using a microphone 220 (e.g., the input module 150 of FIG. 1).

According to an embodiment, the electronic device 201 may determine a first current state of a user using the acquired sensor data. For example, the electronic device 201 may determine that the user 30 is dozing off by analyzing the acquired image and/or audio data. In another example, the electronic device 201 may determine that the user 32 (e.g., a mother) is feeding the user 30 (e.g., a child) by analyzing the acquired image and/or audio data (e.g., a conversation between the user 30 and the user 32).

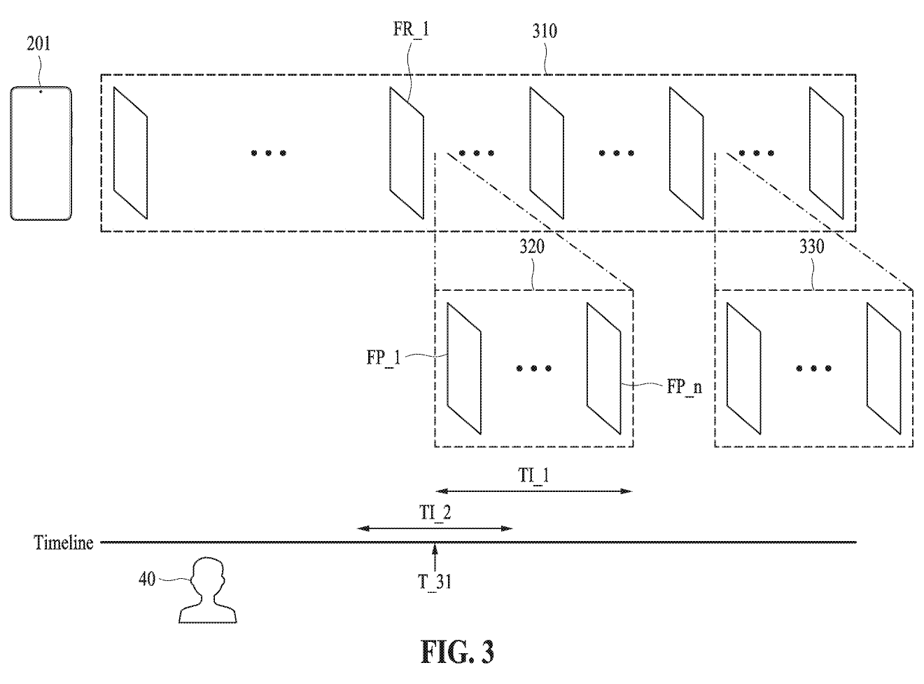

According to an embodiment, the electronic device 201 may determine a target state of a user. In the disclosure, a target state may be a state that a user should achieve while video content (e.g., video content 310 of FIG. 3) is being output or within a certain period of time (e.g., 1 hour) from a time when the output of the video content is ended. For example, when the user 30 is watching an online course video, the target state of the user 30 may be for the user 30 to focus on the online course video.

According to an embodiment, the electronic device 201 may determine the target state of a user based on a property of the video content and the acquired sensor data. The property of the video content may be determined based on information (e.g., type, running time, target audience) related to the video content. The electronic device 201 may determine the target state of the user based on the video content information, when the video content is video content of a first property. For example, when the video content is video content that explicitly requires a specific state (e.g., concentration on a course) of the user, such as an online course video, or is video content that includes information necessary for the user, the electronic device 201 may determine the target state based on information (e.g., type) related to the video content. The electronic device 201 may determine the target state of the user based on the acquired sensor data, when the video content is video content of a second property (e.g., a property different from the first property). For example, when the video content is video content that does not explicitly require a specific state of the user, such as a movie, or when the video content includes information necessary for the user, the electronic device 201 may determine the target state of the user based on sensor data acquired while the video content is being output. For example, while an animation movie is being output from the electronic device 201, the electronic device 201 may detect that the user 30 (e.g., mother) is feeding the user 32 (e.g., child). The electronic device 201 may determine that the target state of the user 32 is eating by analyzing a conversation between the users 30 and 32.

According to an embodiment, the electronic device 201 may determine the target state of the user based on user-related information (e.g., the user's schedule, weather, other devices connected to the electronic device 201, and the user's usage of the electronic device 201). For example, in response to detecting that a user watching video content has a subsequent schedule (e.g., exercise), the electronic device 201 may set the target state to "user exercising," which is a state corresponding to the subsequent schedule. The electronic device 201 may acquire user-related information from data stored in memory (e.g., the memory 130 of FIG. 1). The electronic device 201 may also receive the user-related information from other electronic devices (e.g., the electronic devices 102 and 104, the server 108 of FIG. 1) via a network (e.g., the first network 198, the second network 199 of FIG. 1).

FIG. 3 is a diagram illustrating an operation of providing personalized video content according to an embodiment of the disclosure.

Referring to FIG. 3, according to an embodiment, the electronic device 201 (e.g., the electronic device 101 of FIG. 1) may output the video content 310 (e.g., an online course video, movie). The video content 310 may include image frames and audio data (e.g., voice) corresponding to the image frames.

According to an embodiment, the electronic device 201 may determine a first current state and a target state of a user 40 (e.g., the user 30 or the user 32 of FIG. 2) while the video content 310 is being output. For example, the electronic device 201 may determine the first current state of the user 40 watching an online course video as the user dozing off, and may determine the target state to be the user concentrating on the course.

According to an embodiment, the electronic device 201 may provide first personalized video content 320 to the user 40 based on a difference between the first current state and the target state of the user 40. For example, in response to determining that the first current state does not match the target state, the electronic device 201 may generate and output the first personalized video content 320 (e.g., a video for enticing the user to the target state). In another example, in response to determining that the first current state matches the target state, the electronic device 201 may not generate the first personalized video content 320, or may generate and output the first personalized video content 320 (e.g., a feedback video for the current state including audio data such as "Good job").

According to an embodiment, the electronic device 201 may determine a match (or difference) between the first current state and the target state in various ways. For example, the electronic device 201 may calculate a score indicating a matching degree between the first current state and the target state, and when the calculated score satisfies a threshold value, it may be determined that the first current state matches the target state. The first personalized video content 320 may include image frames FP_1 to FP_n and audio data corresponding to the image frames FP_1 to FP_n.

According to an embodiment, the electronic device 201 may determine the type of the first personalized video content 320 to generate the first personalized video content 320.

According to an embodiment, the electronic device 201 may determine the type of the first personalized video content 320 to be any one of a plurality of preset types. For example, the type of the first personalized video content 320 may be any one of a summary video (e.g., a course summary video) of the video output so far, a video for confirming an intention of the user 40, a feedback video for the first current state of the user 40, and a video for enticing the user 40 to a target state.

According to an embodiment, the electronic device 201 may determine the type of the first personalized video content 320 based on information (e.g., a type) related to the video content 310. For example, when the video content 310 is video content (e.g., an online course video, election promotion video) that includes information necessary for the user 40, the type of the first personalized video content 320 may be determined as a summary video.

According to an embodiment, the electronic device 201 may determine the type of the first personalized video content 320 based on user-related information (e.g., the user's schedule). For example, when the remaining playback time of the video content 310 is 1 hour and a subsequent schedule (e.g., exercise) of the user 40 is scheduled 1 hour later, the electronic device 201 may output a video (e.g., a video including audio data such as "Would you like to output the summary video") to confirm whether the user wants to watch a summary video of the remaining video.

According to an embodiment, the electronic device 201 may determine the importance of information included in image frames of the video content 310 and audio data corresponding to the image frames to generate the summary video. For example, a main section (e.g., a main section 84 of FIG. 8) and a non-main section (e.g., a non-main section 82 of FIG. 8) of the video content 310 may be summarized at different levels, respectively.

According to an embodiment, the electronic device 201 may estimate an amount of time required to generate the first personalized video content 320, based on the type of the first personalized video content 320. The amount of time required to generate the first personalized video content 320 may vary depending on the type of the first personalized video content 320.

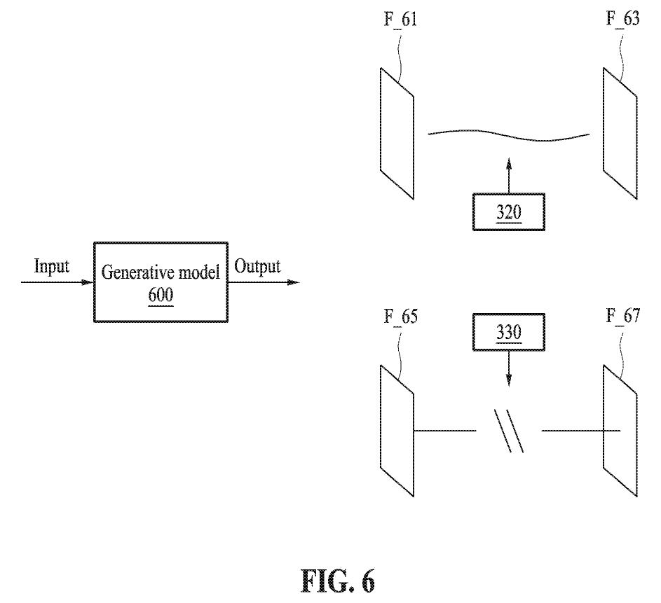

According to an embodiment, the electronic device 201 may determine an output timepoint T_31 of the first personalized video content 320 based on the estimated amount of time. The determining of the output timepoint T_31 of the first personalized video content 320 is described in detail with reference to FIGS. 6 and 8.

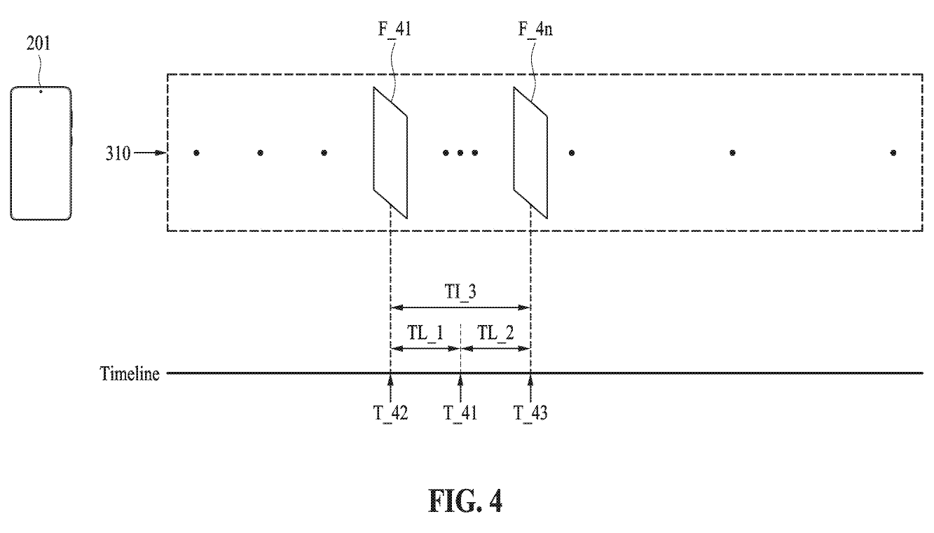

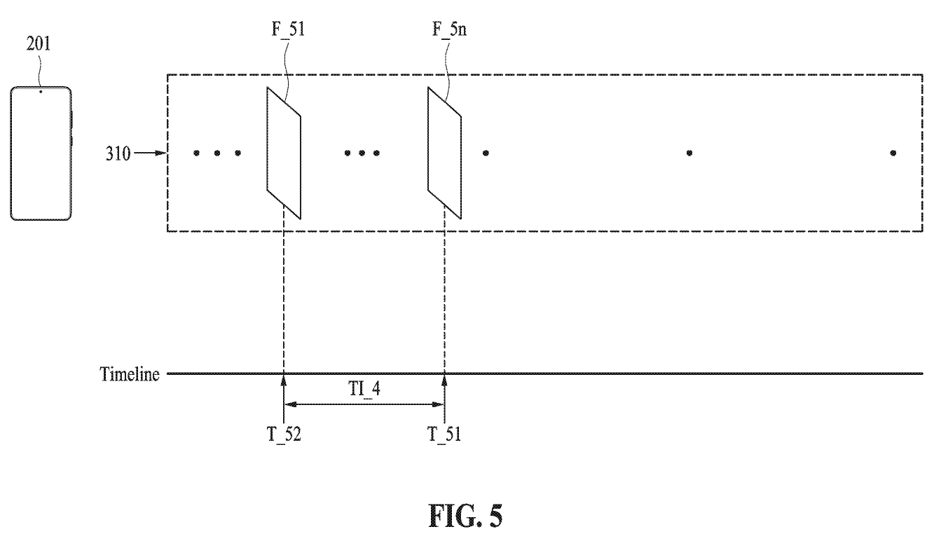

According to an embodiment, the electronic device 201 may generate the first personalized video content 320 (e.g., the image frames FP_1 to FP_n and audio data corresponding to the image frames FP_1 to FP_n) based on the determined output timepoint T_31 of the first personalized video content 320. The generating of the first personalized video content 320 is described in detail with reference to FIGS. 4 and 5.

According to an embodiment, the electronic device 201 may embed the first personalized video content 320 (e.g., the image frames FP_1 to FP_n and audio data corresponding to the image frames FP_1 to FP_n) between a reference image frame FR_1 of the video content 310 and a next image frame of the reference image frame FR_1. As the first personalized video content 320 is embedded into the video content 310, the total running time of the video content 310 may increase compared to the original running time.

According to an embodiment, in place of embedding the first personalized video content 320 (e.g., the image frames FP_1 to FP_n and audio data corresponding to the image frames FP_1 to FP_n) into the video content 310, the electronic device 201 may generate the first personalized video content 320 as a separate file (e.g., a media file) distinct from the video content 310 file. The electronic device 201 may output the first personalized video content 320 generated as a separate file between specific frames of the video content 310.

According to an embodiment, the electronic device 201 may determine a third current state of the user 40 to output the first personalized video content 320. The electronic device 201 may acquire sensor data during a detection time interval using sensors (e.g., the camera sensor 210 and microphone 220 of FIG. 2) to determine the third current state of the user. The detection time interval may be determined based on the output timepoint T_31. For example, the detection time interval may be a time interval TI_1 within a predetermined time length from the output timepoint T_31. In another example, the detection time interval may be a time interval TI_2 between two timepoints before and after the output timepoint T_31. The electronic device 201 may output the first personalized video content 320 in response to determining that the third current state of the user 40 matches a predetermined user state (e.g., the user is gazing at the electronic device 201). In response to determining that the third current state (e.g., the user is not gazing at the electronic device 201) of the user 40 does not match the predetermined user state, the electronic device 201 may output the video content 310 (e.g., the original video content 310) excluding the first personalized video content 320 (e.g., the image frames FP_1 to FP_n and audio data corresponding to the image frames FP_1 to FP_n). In response to determining that the third current state of the user 40 does not match the predetermined user state, the electronic device 201 may generate an indicator indicating a generation location (or insertion location) of the first personalized video content 320 within the video content 310 on a timeline of the video content 310.

According to an embodiment, the electronic device 201 may acquire sensor data related to the user 40 using sensors (e.g., the camera sensor 210 and the microphone 220 of FIG. 2) for a certain period of time after the output of the first personalized video content 320 is initiated. The electronic device 201 may determine a fourth current state of the user 40 using the acquired sensor data. The electronic device 201 may provide second personalized video content 330 to the user 40 based on a difference (or match) between the fourth current state and the target state.

According to an embodiment, the electronic device 201 may generate and output the second personalized video content 330 in the same or similar manner as the first personalized video content 320 described above, except for the difference between the first personalized video content 320 and the second personalized video content 330 described with reference to FIG. 6. Accordingly, a repeated description thereof is omitted.

FIGS. 4 and 5 are diagrams illustrating a method of generating personalized video content according to various embodiments of the disclosure.

Referring to FIGS. 4 and 5, according to an embodiment, the electronic device 201 may use one or more frames among image frames F_41 to F_4n and F_51 to F_5n within a reference time interval of the video content 310 and audio data (e.g., voice data) corresponding to the one or more frames to generate personalized video content (e.g., the first personalized video content 320 and the second personalized video content 330 of FIG. 3). The electronic device 201 may determine a reference time interval of the video content 310 based on an output timepoint T_41 or T_51 (e.g., the determined output timepoint T_31 of FIG. 3) of the personalized video content.

Referring to FIG. 4, according to an embodiment, the electronic device 201 may determine a time interval TI_3 between a first timepoint T_42 and a second timepoint T_43 as a reference time interval of the video content 310. The electronic device 201 may determine a timepoint that is ahead of the output timepoint T_41 by a first time length TL_1 to be the first timepoint T_42. The electronic device 201 may determine a timepoint delayed by a second time length TL_2 from the output timepoint T_41 to be the second timepoint T_43.

The electronic device 201 may determine the first time length TL_1 and the second time length TL_2 based on information (e.g., a type, running time, remaining playback time) related to the video content 310 and/or user-related information (e.g., a user's schedule). For example, the electronic device 201 may determine the first time length TL_1 and the second time length TL_2 to be proportional to the length of the remaining playback time of the video content 310. In another example, the electronic device 201 may determine the first time length TL_1 and the second time length TL_2 to be short when there is a subsequent schedule of a user (e.g., the user 40 of FIG. 3) watching the video content 310.

Referring to FIG. 5, according to an embodiment, the electronic device 201 may determine a time interval TI_4 between a timepoint T_52 prior to the output timepoint T_51 and the output timepoint T_51 to be a reference time interval of the video content 310.

According to an embodiment, the electronic device 201 may determine the timepoint T_52 based on one or more of a property of the video content 310 and a current state of a user (e.g., the user 40 of FIG. 3) watching the video content 310. For example, when the video content 310 is video content that explicitly requires a specific state (e.g., concentration on a course) of the user, such as an online course video, or video content that includes information necessary for the user, the electronic device 201 may determine the timepoint T_52 to be a timepoint when it is first determined that the current state of the user 40 does not match the target state (e.g., when the user starts to doze off).

According to an embodiment, the electronic device 201 may generate the personalized video content using a portion of image frames among image frames F_51 to F_5n located within a reference time interval and audio data corresponding to the portion of image frames. For example, the electronic device 201 may use image frames corresponding to time intervals in which the current state of the user 40 does not match the target state among the image frames F_51 to F_5n.

FIG. 6 is a diagram illustrating the difference between first personalized video content and second personalized video content according to an embodiment of the disclosure.

Referring to FIG. 6, according to an embodiment, the amount of output time of the first personalized video content 320 and the amount of output time of the second personalized video content 330 may be different. The amount of output time of the first personalized video content 320 may correspond to the length of audio data (e.g., voice data such as "Please concentrate on the course") included in the first personalized video content 320. The amount of output time of the second personalized video content 330 may be determined based on sensor data acquired after the output of the second personalized video content 330 is initiated. An electronic device (e.g., the electronic device 101 of FIG. 1, the electronic device 201 of FIGS. 2 to 5) may output the second personalized video content 330 (e.g., a video including audio data such as "Logan, if you don’t eat, I can’t show you PAW Patrol anymore. Come on, let’s eat") during a time interval in which a current state (e.g., not eating) of a user (e.g., a child) determined based on sensor data does not match a target state (e.g., eating). As the second personalized video content 330 is output until the current state of the user matches the target state, the output of the video content (e.g., the video content 310 of FIG. 3) that the user was watching may be interrupted for a long time.

According to an embodiment, the electronic device 101 or 201 may use an artificial intelligence (AI) model to generate the first personalized video content 320 and the second personalized video content 330.

According to an embodiment, the AI model (or AI neural network) may include various foundation models such as a language model, a code model, an image model, and/or other AI neural network models. The AI model may include a large language model (LLM) and/or a large vision model (LVM). For ease of description, the disclosure describes an LLM and/or an LVM as examples.

The AI model that may be used in the disclosure may include an LLM, which is an AI neural network-based language model that learns a large amount of text data through pre-training. The LLM may include a relatively greater number of parameters (e.g., approximately 10 billion or more) than existing general language models. The LLM may use a transformer AI neural network structure based on an attention mechanism.

According to an embodiment, the training of the LLM may include pre-training and/or fine-tuning. Pre-training may include training the LLM to acquire general language knowledge using a large amount of text data. For example, the pre-training may include self-supervised learning, which predicts the next word in a text string using a previous word string. Fine-tuning may include training the LLM to be suitable for a specific domain (e.g., a chatbot, AI assistant, translation, summary generation, question answering) and/or task. The fine-tuning may include additional training (e.g., supervised learning, adaptive learning) of the LLM using a dataset corresponding to the specific domain and/or task based on a pre-trained model. The LLM may perform a task based on text input including natural language, referred to as a prompt.

According to an embodiment, fine-tuning may be omitted in the training of the LLM. A user may control a prompt to be input to the LLM to improve performance on a desired task. For example, a user may control a prompt such that additional examples of a task and/or guidance for performing the task are provided, such as in-context learning, zero-shot learning, and/or few-shot learning. Publicly available LLMs may include Bidirectional Encoder Representations from Transformer (BERT) and generative pre-trained transformer (GPT).

The term "LLM" may refer to the language neural network model itself, but may also refer to the model of an LLM-based application (e.g., chatbot, AI assistant, translation, summary generation, text classification, sentence generation). For example, an LLM-based chatbot such as ChatGPT or an LLM-based translator may also be referred to as an "LLM."

An "LLM" may include an inference engine using an LLM neural network model. For example, "inputting an input prompt to the LLM" may be "inputting an input prompt to an LLM-based inference engine." For example, "an output of the LLM for the input prompt" may be output information of the last neural network layer of the LLM acquired when the input prompt is input to the LLM-based inference engine, and/or output information modified through additional processing.

The attention mechanism may be a technique that allows an AI model to focus on (attention) important parts of input data. The attention mechanism may be used to predict output data by predicting the extent to which a portion of time-series input data (e.g., time-series input data such as voice or video, or input data of some layers of a neural network) contributes to the output of intermediate layers of the neural network and/or the final output. While a recurrent neural network (RNN) structure, which sequentially processes each element of a sequence, may have poor prediction performance when there is information dependency across long time-series distances, the attention mechanism may consider information dependency across long time-series distances by controlling the level of attention within the entire and/or partial context of the input data. A transformer may be configured in an encoder-decoder structure. An encoder may process input data and output compressed information (e.g., contextual representation). A decoder may process the compressed information and output data in token units. The encoder and decoder may each include an independent attention network, and may further include a cross-attention network connecting the encoder and decoder.

According to an embodiment, the electronic device 101 or 201 may use an AI model to generate the first personalized video content 320 and the second personalized video content 330. A generative model 600 may be used.

According to an embodiment, the electronic device 201 may input image frames (e.g., one or more of the image frames F_41 to F_4n of FIG. 4 or the image frames F_51 to F_5n of FIG. 5) acquired based on a reference time interval (e.g., the time interval TI_3 of FIG. 4, the time interval TI_4 of FIG. 5) and audio data (e.g., voice data) corresponding to the acquired image frames to the generative model 600.

According to an embodiment, the electronic device 201 may generate audio data based on a difference (or match) between the current state and the target state of a user (e.g., the user 40 of FIG. 3). For example, when the electronic device 201 detects that the user 40 watching an online course video is dozing off, the electronic device 201 may synthesize audio data such as "Please concentrate on the course" based on voice data of the instructor so that the user 40 may concentrate on the course. In another example, when the electronic device 201 detects that a child watching an animation movie during mealtime is not eating, the electronic device 201 may synthesize audio data such as "Logan, if you don’t eat, you can’t be a friend of PAW Patrol. Come on, let’s eat" based on voice data of an animation character.

According to an embodiment, the electronic device 201 may input a prompt to the generative model 600 to generate the first personalized video content 320 and/or the second personalized video content 330. The electronic device 201 may generate a prompt corresponding to each of the first personalized video content 320 and the second personalized video content 330.

According to an embodiment, the electronic device 201 may generate a prompt such that the first personalized video content 320 seamlessly connects image frames F_61 and F_63 of the video content 310 positioned before and after the first personalized video content 320. As the first personalized video content seamlessly connects the image frames F_61 and F_63 of the video content (e.g., the video content 310 of FIG. 3), the first personalized video content 320 may not interfere with the user's viewing of the video content 310.

According to an embodiment, the electronic device 201 may generate a prompt such that the second personalized video content 330 discontinuously connects image frames F_65 and F_67 of the video content 310 positioned before and after the second personalized video content 330. For example, the image frames (e.g., the image frames of FIG. 3) of the second personalized video content 330 may include a background image (e.g., a background image of a single color such as black) that is different from a background image included in the image frames of the video content 310 positioned before and after the second personalized video content 330.

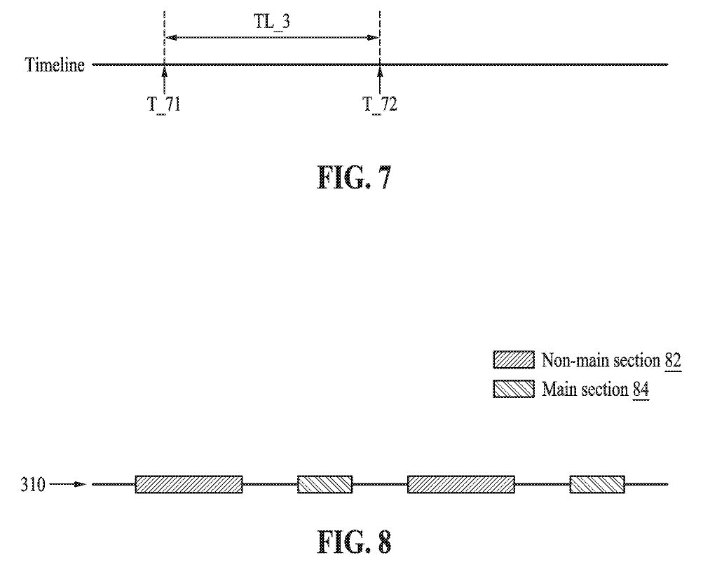

FIG. 7 is a diagram illustrating an operation of determining an output timepoint of personalized video content according to an embodiment of the disclosure.

Referring to FIG. 7, according to an embodiment, an electronic device (e.g., the electronic device 101 of FIG. 1, the electronic device 201 of FIGS. 2 to 5) may determine an output timepoint of the personalized video content 320 or 330 based on an amount of time TL_3 required to generate the personalized video content (e.g., the first personalized video content 320 and the second personalized video content 330 of FIGS. 3 and 6). For example, the electronic device 101 or 201 may determine an output timepoint T_72 (e.g., the output timepoint T_31 of FIG. 3) by adding the amount of time TL_3 required to generate the personalized video content to a current timepoint T_71.

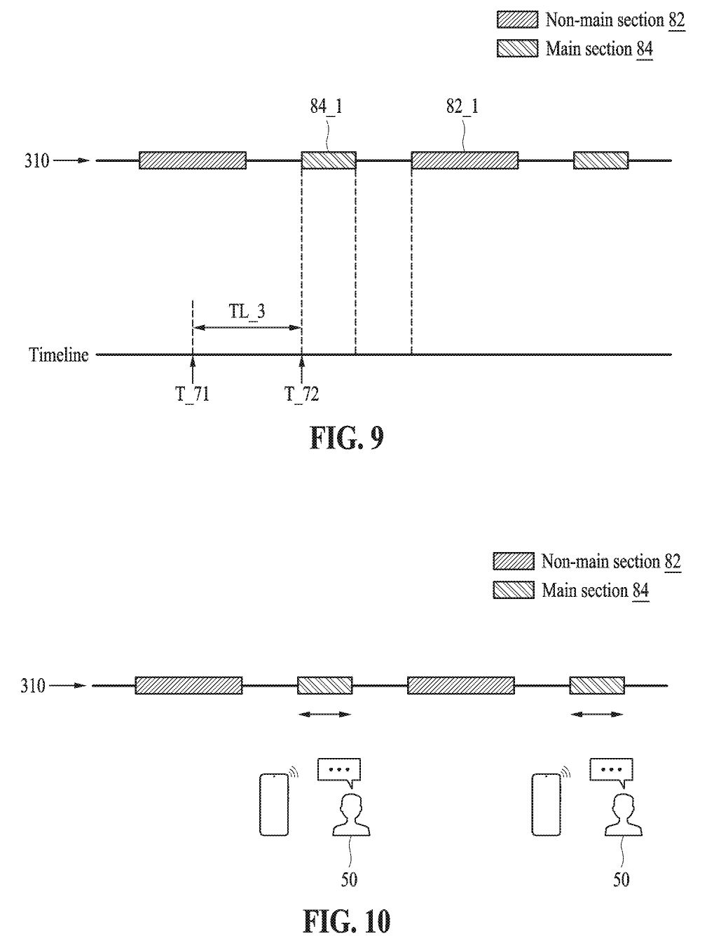

According to an embodiment, the electronic device 101 or 201 may determine the output timepoint of the personalized video content 320 or 330 based on video sections of video content (e.g., the video content 310 of FIGS. 3 to 5). The determining of the output timepoint of the personalized video content 320 or 330 based on the video sections of the video content 310 is described in detail with reference to FIG. 9.

FIG. 8 is a diagram illustrating a method of setting a section of video content according to an embodiment of the disclosure.

Referring to FIG. 8, according to an embodiment, an electronic device (e.g., the electronic device 101 of FIG. 1, the electronic device 201 of FIGS. 2 to 5) may divide the video content 310 into several types of video sections. For example, the electronic device 101 or 201 may divide the video content 310 into the non-main section 82 and the main section 84.

According to an embodiment, the electronic device 101 or 201 may divide the video content 310 into the non-main section 82 and the main section 84 by analyzing image frames of the video content 310 and/or audio data corresponding to the image frames. For example, the electronic device 101 or 201 may use analysis algorithms such as contextual analysis and/or scene analysis. For example, the electronic device 101 or 201 may divide the video content 310 into the non-main section 82 and the main section 84 based on whether an image frame includes a character, the transition of a scene, the number of times each of the image frames is played, and the end of a chapter in an online course video. In another example, the non-main section 82 and the main section 84 of the video content 310 may be provided by a producer of the video content 310.

According to an embodiment, the electronic device 101 or 201 may use a neural network (e.g., a content analysis model) to divide the video content 310 into the non-main section 82 and the main section 84.

FIG. 9 is a diagram illustrating an operation of determining an output timepoint of personalized video content according to an embodiment of the disclosure.

Referring to FIG. 9, according to an embodiment, an electronic device (e.g., the electronic device 101 of FIG. 1, the electronic device 201 of FIGS. 2 to 5) may determine an output timepoint of personalized video content (e.g., the first personalized video content 320 and/or the second personalized video content 330 of FIGS. 3 and 6) based on the non-main section 82 and the main section 84 of the video content 310. For example, when the output timepoint T_72 calculated based on the amount of time TL_3 required for generating the personalized video content 320 or 330 is included in a main section 84_1 of the video content 310, the electronic device 101 or 201 may determine the output timepoint to be the end time of the main section 84_1 or the start time of a non-main section 82_1 following the main section 84_1.

FIG. 10 is a diagram illustrating an operation of determining a user state according to an embodiment of the disclosure.

Referring to FIG. 10, according to an embodiment, an electronic device (e.g., the electronic device 101 of FIG. 1, the electronic device 201 of FIGS. 2 to 5) may acquire sensor data to determine a current state of a user 50 (e.g., the user 30 or the user 32 of FIG. 1, the user 40 of FIG. 3) while a specific video section of the video content 310 is being output. For example, the electronic device 201 may acquire sensor data only while the main section 84 of the video content 310 is being output.

According to an embodiment, the electronic device 101 or 201 may minimize power consumption of the electronic device 101 or 201 by acquiring sensor data only while a specific video section of the video content 310 is being output.

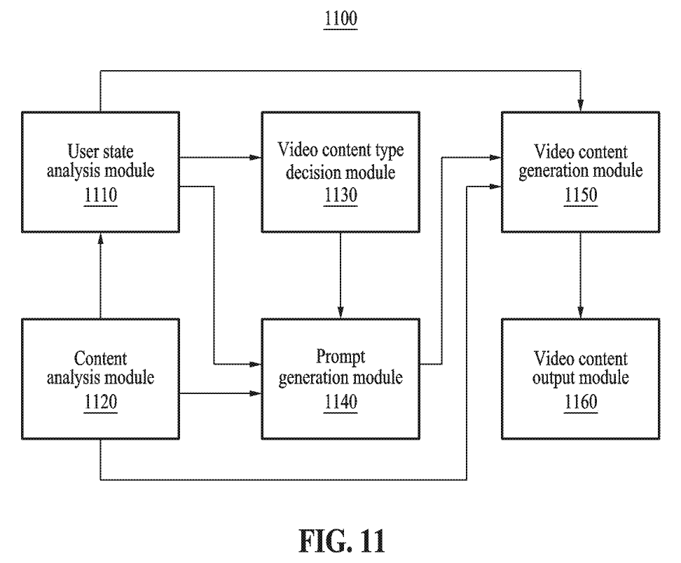

FIG. 11 is a schematic block diagram of a system for generating personalized content according to an embodiment of the disclosure.

Referring to FIG. 11, according to an embodiment, a personalized video content system 1100 may include a user state analysis module 1110, a content analysis module 1120, a video content type decision module 1130, a prompt generation module 1140, a video content generation module 1150, and a video content output module 1160. The modules 1110 to 1160 included in the personalized video content system 1100 may represent functions performed by an electronic device (e.g., the electronic device 101 of FIG. 1, the electronic device 201 of FIGS. 2 to 5). A processor (e.g., the processor 120 of FIG. 1) of the electronic device 101 or 201 may cause the electronic device 101 or 201 to perform functions of the modules 1110 to 1160 by executing instructions stored in memory (e.g., the memory 130 of FIG. 1). The functions of the modules 1110 to 1160 may be substantially the same as the operations of the electronic device 101 or 201 described with reference to FIGS. 1 to 10. Accordingly, a repeated description thereof is omitted.

According to an embodiment, the user state analysis module 1110 may determine a user state (e.g., a current state, target state) based on sensor data and user-related information. The user state analysis module 1110 may transmit user state information to the content analysis module 1120 and the video content generation module 1150.

According to an embodiment, the content analysis module 1120 may determine image frames of video content (e.g., the video content 310 of FIG. 1) to be used in generating personalized video content (e.g., the first personalized video content 320 and the second personalized video content 330 of FIG. 3), and transmit the determined image frames and corresponding audio data to the video content generation module 1150.

According to an embodiment, the video content type decision module 1130 may determine the type of the personalized video content 320 or 330. The video content type decision module 1130 may determine a level of the personalized video content to entice a user to a target state, and may change the level of the personalized video content based on the current state of the user acquired after the personalized video content of the determined level is output.

According to an embodiment, the prompt generation module 1140 may generate a prompt necessary for generating the personalized video content 320 or 330, and transmit the prompt to the video content generation module 1150. The prompt may include information related to the form and composition of the personalized video content 320 or 330. The prompt may include information (e.g., a message such as "Please concentrate on the course") intended to entice a user to a target state.

According to an embodiment, the video content generation module 1150 may include a generation model. The video content generation module 1150 may generate the personalized video content 320 or 330 (e.g., image frames, audio data).

According to an embodiment, the video content output module 1160 may output the personalized video content 320 or 330 (e.g., image frames, audio data).

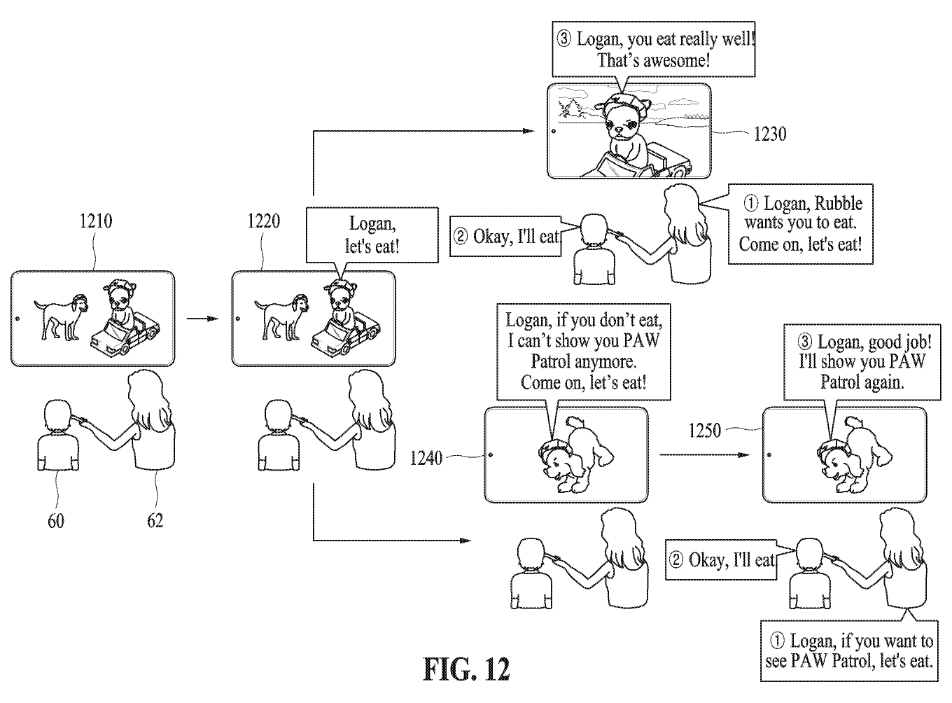

FIG. 12 is a diagram illustrating an example of a situation in which personalized content is provided, according to an embodiment of the disclosure.

Referring to FIG. 12, according to an embodiment, an electronic device (e.g., the electronic device 101 of FIG. 1, the electronic device 201 of FIGS. 2 to 5) may acquire sensor data (e.g., image, audio data) through sensors (e.g., the camera sensor 210 and the microphone 220 of FIG. 2). The electronic device 101 or 201 may analyze a state (e.g., current state, target state) of a user based on the sensor data. The electronic device 101 or 201 may generate and output personalized video content (e.g., the first personalized video content 320 and/or the second personalized video content 330 of FIG. 3) based on the analyzed state of the user.

In operation 1210, the electronic device 101 or 201 may output video content (e.g., the video content 310 of FIGS. 3 to 5 and 8 to 10). For example, the electronic device 101 or 201 may output an animation movie. While the video content 310 is being output, a user 62 (e.g., a mother) may try to feed a user 60 (e.g., a child), and the user 60 may not be eating because he or she is watching the video content 310. The electronic device 101 or 201 may capture an image including such contextual information. The electronic device 101 or 201 may acquire audio data including a conversation between the users 60 and 62 (e.g., "Logan, let’s eat," "No, I won’t eat").

In operation 1220, the electronic device 101 or 201 may output first personalized video content (e.g., the first personalized video content 320 of FIGS. 3 and 6) in response to determining that a current state of the user 60 does not match a target state. The first personalized video content 320 may include voice data (e.g., "Logan! If you don’t eat, you can’t be a friend of PAW Patrol. Come on, let’s eat!") for enticing the user 60 to the target state.

In operation 1230, the electronic device 101 or 201 may output second personalized video content (e.g., the second personalized video content 330 of FIGS. 3 and 6) in response to determining that the current state of the user 60 matches the target state after the first personalized video content 320 is output. The second personalized video content 330 may include a feedback voice (e.g., "Logan! You eat really well! That’s awesome!") related to the current state of the user 60.

In operations 1240 and 1250, the electronic device 101 or 201 may output the second personalized video content 330 in response to determining that the current state of the user 60 does not match the target state after the first personalized video content 320 is output. The second personalized video content 330 may include voice data (e.g., "Logan! If you don’t eat, I can’t show you PAW Patrol anymore. Come on, let’s eat!") for enticing the user 60 to the target state. The electronic device 101 or 201 may entice (or guide) the user 60 to the target state (e.g., eating) by outputting the second personalized video content 330 until the current state of the user 60 matches the target state.

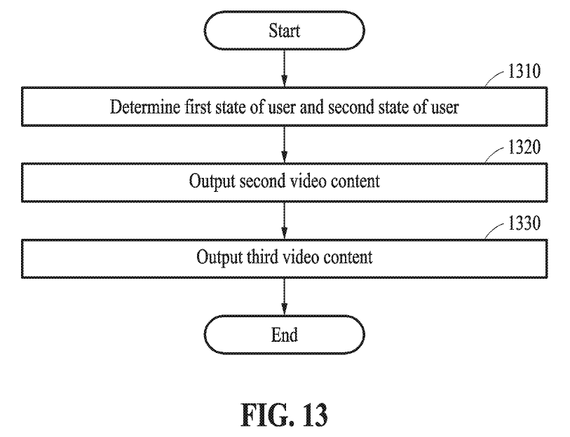

FIG. 13 is a flowchart illustrating an operation of an electronic device according to an embodiment of the disclosure.

Referring to FIG. 13, according to an embodiment, operations 1310 to 1330 may be sequentially performed, but embodiments are not limited thereto. For example, two or more operations may be performed in parallel. Operations 1310 to 1330 may be substantially the same as the operations of the electronic device (e.g., the electronic device 101 of FIG. 1, the electronic device 201 of FIGS. 2 to 5) described with reference to FIGS. 1 to 12. Accordingly, a repeated description thereof is omitted.

In operation 1310, the electronic device 101 or 201 may determine, respectively, a first state (e.g., a current state) and a second state (e.g., a target state) of a user (e.g., the user 30 or the user 32 of FIG. 2, the user 40 of FIG. 3, the user 50 of FIG. 10, the user 60 or the user 62 of FIG. 12), based on one or more of a property of first video content (e.g., the video content 310 of FIGS. 3 to 5 and 8 to 10) and first sensor data acquired while the first video content 310 is being output.

In operation 1320, the electronic device 101 or 201 may output second video content (e.g., the first personalized video content 320 of FIG. 2) including second image frames (e.g., the image frames FP_1 to FP_n of FIG. 2) embedded between first image frames of the first video content 310, based on a difference (or match) between the first state and the second state.

In operation 1330, the electronic device 101 or 201 may output third video content (e.g., the second personalized video content 330 of FIG. 3) including fourth image frames embedded after a third image frame of the first video content 310, based on second sensor data acquired after the output of the second video content 320 is initiated.

The electronic device 101 or 201 according to an embodiment may include the at least one processor 120. The electronic device 101 or 201 may include the memory 130 that stores instructions. The instructions, when executed by the at least one processor 120 individually or collectively, may cause the electronic device 101 or 201 to determine, respectively, a first state of the user 30, 32, 40, 50, 60, or 62 and a second state of the user 30, 32, 40, 50, 60, or 62, based on one or more of a property of the first video content 310 and first sensor data acquired while the first video content 310 is being output. The instructions, when executed by the at least one processor 120 individually or collectively, may cause the electronic device 101 or 201 to output the second video content 320 including the second image frames FP_1 to FP_n temporally positioned between first image frames of the first video content 310, based on a difference between the first state and the second state. The instructions, when executed by the at least one processor 120 individually or collectively, may cause the electronic device 101 or 201 to output the third video content 330 including fourth image frames temporally positioned after a third image frame of the first video content 310, based on second sensor data acquired after the output of the second video content 320 is initiated. The third image frame may be positioned after the first image frames.

According to an embodiment, the instructions, when executed by the at least one processor 120 individually or collectively, may cause the electronic device 101 or 201 to determine the first state based on the first sensor data. The instructions, when executed by the at least one processor 120 individually or collectively, may cause the electronic device 101 or 201 to determine the second state based on a property of the first video content 310 when the first video content 310 is video content of a first property. The instructions, when executed by the at least one processor 120 individually or collectively, may cause the electronic device 101 or 201 to determine the second state based on the first sensor data when the first video content 310 is video content of a second property.

According to an embodiment, the instructions, when executed by the at least one processor 120 individually or collectively, may cause the electronic device 101 or 201 to determine a type of the second video content 320 based on information related to the first video content 310. The instructions, when executed by the at least one processor 120 individually or collectively, may cause the electronic device 101 or 201 to output the second image frames FP_1 to FP_n corresponding to the type of the second video content 320.

According to an embodiment, the instructions, when executed by the at least one processor 120 individually or collectively, may cause the electronic device 101 or 201 to determine an output timepoint of the second video content 320 based on the type of the second video content 320. The instructions, when executed by the at least one processor 120 individually or collectively, may cause the electronic device 101 or 201 to generate the second image frames FP_1 to FP_n based on one or more of the type of the second video content 320 and the output timepoint of the second video content 320. The instructions, when executed by the at least one processor 120 individually or collectively, may cause the electronic device 101 or 201 to output the second image frames FP_1 to FP_n after a reference image frame of the first video content 310 corresponding to the output timepoint.

According to an embodiment, the instructions, when executed by the at least one processor 120 individually or collectively, may cause the electronic device 101 or 201 to estimate an amount of time for generating the second image frames FP_1 to FP_n based on the type of the second video content 320. The instructions, when executed by the at least one processor 120 individually or collectively, may cause the electronic device 101 or 201 to determine the output timepoint of the second video content 320 based on the amount of time.

According to an embodiment, the output timepoint of the second video content 320 may include any one of a first output timepoint acquired by adding the amount of time to a current time and a second output timepoint after the first output timepoint. The second output timepoint may include an output timepoint within a specific section of the first video content 310 positioned after the first output timepoint.

According to an embodiment, the instructions, when executed by the at least one processor 120 individually or collectively, may cause the electronic device 101 or 201 to generate the second image frames FP_1 to FP_n using an image frame positioned before the reference image frame when the second video content 320 is video content of a first type. The instructions, when executed by the at least one processor 120 individually or collectively, may cause the electronic device 101 or 201 to generate the second image frames FP_1 to FP_n using one or more of an image frame positioned before the reference image frame and an image frame positioned after the reference image frame when the second video content 320 is video content of a second type.

According to an embodiment, the instructions, when executed by the at least one processor 120 individually or collectively, may cause the electronic device 101 or 201 to output the second image frames FP_1 to FP_n based on third sensor data acquired within a predetermined time interval TI_1 or TI_2 from the output timepoint.

According to an embodiment, the instructions, when executed by the at least one processor 120 individually or collectively, may cause the electronic device 101 or 201 to determine a third state of the user based on the third sensor data. The instructions, when executed by the at least one processor 120 individually or collectively, may cause the electronic device 101 or 201 to output the second image frames FP_1 to FP_n in response to the third state matching a predetermined state.

According to an embodiment, the instructions, when executed by the at least one processor 120 individually or collectively, may cause the electronic device 101 or 201 to determine a fourth state of the user based on the second sensor data.

According to an embodiment, the instructions, when executed by the at least one processor 120 individually or collectively, may cause the electronic device 101 or 201 to output the third video content 330 based on a difference between the fourth state and the second state.

According to an embodiment, the second image frames FP_1 to FP_n may be generated using the generative model 600 such that the first image frames are seamlessly connected to each other through the second image frames FP_1 to FP_n.

According to an embodiment, the fourth image frames may include a background image different from a background image included in the third image frame.

According to an embodiment, an amount of time during which the third video content 330 is output may be determined based on a time interval during which the fourth state does not match the second state.

A method of operating the electronic device 101 or 201 according to an embodiment may include determining, respectively, a first state of the user 30, 32, 40, 50, 60, or 62 and a second state of the user 30, 32, 40, 50, 60, or 62, based on one or more of a property of the first video content 310 and first sensor data acquired while the first video content 310 is being output. The method may include outputting the second video content 320 including the second image frames FP_1 to FP_n temporally positioned between first image frames of the first video content 310, based on a difference between the first state and the second state. The method may include outputting the third video content 330 including fourth image frames temporally positioned after a third image frame of the first video content 310, based on second sensor data acquired after the output of the second video content 320 is initiated. The third image frame may be positioned after the first image frames.

According to an embodiment, the determining, respectively, of the first state of the user and the second state of the user 30, 32, 40, 50, 60, or 62 may include determining the first state based on the first sensor data. The determining, respectively, of the first state of the user and the second state of the user 30, 32, 40, 50, 60, or 62 may include determining the second state based on a property of the first video content 310 when the first video content 310 is video content of a first property. The determining, respectively, of the first state of the user and the second state of the user 30, 32, 40, 50, 60, or 62 may include determining the second state based on the first sensor data when the first video content 310 is video content of a second property.

According to an embodiment, the outputting of the second video content 320 may include determining a type of the second video content 320 based on information related to the first video content 310. The outputting of the second video content 320 may include outputting the second image frames FP_1 to FP_n corresponding to the type of the second video content 320.

According to an embodiment, the outputting of the second image frames FP_1 to FP_n may include determining an output timepoint of the second video content 320 based on the type of the second video content 320. The outputting of the second image frames FP_1 to FP_n may include generating the second image frames FP_1 to FP_n based on one or more of the type of the second video content 320 and the output timepoint. The operation of outputting the second image frames FP_1 to FP_n may include outputting the second image frames FP_1 to FP_n after a reference image frame of the first video content 310 corresponding to the output timepoint.

According to an embodiment, the determining of the output timepoint of the second video content 320 may include estimating an amount of time for generating the second image frames FP_1 to FP_n based on the type of the second video content 320. The determining of the output timepoint of the second video content 320 may include determining the output timepoint of the second video content 320 based on the amount of time.

According to an embodiment, the output timepoint of the second video content 320 may include any one of a first output timepoint acquired by adding the amount of time to a current time and a second output timepoint after the first output timepoint. The second output timepoint may include an output timepoint within a specific section of the first video content 310 positioned after the first output timepoint.

According to an embodiment, the generating of the second image frames FP_1 to FP_n may include generating the second image frames FP_1 to FP_n using an image frame positioned before the reference image frame when the second video content 320 is video content of a first type. The generating of the second image frames FP_1 to FP_n may include generating the second image frames FP_1 to FP_n using one or more of an image frame positioned before the reference image frame and an image frame positioned after the reference image frame when the second video content 320 is video content of a second type.

According to an embodiment, the outputting of the second image frames FP_1 to FP_n after the reference image frame of the first video content 310 corresponding to the output timepoint may include outputting the second image frames FP_1 to FP_n based on third sensor data acquired within a predetermined time interval TI_1 or TI_2 from the output timepoint.

According to an embodiment, the outputting of the second image frames FP_1 to FP_n based on the third sensor data may include determining the third state of the user based on the third sensor data. The outputting of the second image frames FP_1 to FP_n based on the third sensor data may include outputting the second image frames FP_1 to FP_n in response to the third state matching a predetermined state.

According to an embodiment, the outputting of the third video content 330 may include determining the fourth state of the user based on the second sensor data. The outputting of the third video content 330 may include outputting the third video content 330 based on a difference between the fourth state and the second state.

According to an embodiment, the second image frames FP_1 to FP_n may be generated using the generative model 600 such that the first image frames are seamlessly connected to each other through the second image frames FP_1 to FP_n.

According to an embodiment, the fourth image frames may include a background image different from a background image included in the third image frame.

According to an embodiment, an amount of time during which the third video content 330 is output may be determined based on a time interval during which the fourth state does not match the second state.

The electronic device 101 or 201 according to an embodiment may include the at least one processor 120. The electronic device 101 or 201 may include the memory 130 that stores instructions. The instructions, when executed by the at least one processor 120 individually or collectively, may cause the electronic device 101 or 201 to determine, respectively, a current state of the user 30, 32, 40, 50, 60, or 62 and a target state of the user 30, 32, 40, 50, 60, or 62, based on one or more of a property of the first video content 310 and sensor data acquired while the first video content 310 is being output. The instructions, when executed by the at least one processor 120 individually or collectively, may cause the electronic device 101 or 201 to generate the second video content 320 based on a difference between the current state and the target state. The instructions, when executed by the at least one processor 120 individually or collectively, may cause the electronic device 101 or 201 to output the second video content after a reference image frame of the first video content, which may be determined based on an amount of time required for generating the second video content.

According to an embodiment, a non-transitory computer-readable storage medium storing one or more computer programs may include instructions that cause a processor to perform the method described above.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that various embodiments of the disclosure and the terms used therein are not intended to limit the technological features set forth herein to particular embodiments and include combinations of embodiments, various modifications, equivalents, or substitutes for a corresponding embodiment. With regard to the description of the drawings, similar reference numerals may be used to refer to similar or related components. As used herein, each of such phrases as "A or B," "at least one of A and B," "at least one of A or B," "A, B or C," "at least one of A, B and C," and "at least one of A, B, or C," may include any one of the items listed together in the corresponding one of the phrases, or all possible combinations thereof. Terms such as "1st" and "2nd," or "first" and "second" may be used to simply distinguish a corresponding component from other components, and do not limit the components in other aspects (e.g., importance or order). It is to be understood that if an element (e.g., a first element) is referred to, with or without the term "operatively" or "communicatively," as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140 of FIG. 1) including one or more instructions that are stored in a storage medium (e.g., the internal memory 136 or the external memory 138 of FIG. 1) that is readable by a machine (e.g., the electronic device 101 of FIG. 1, the electronic device 201 of FIG. 2). For example, a processor (e.g., the processor 120 of FIG. 1) of the machine (e.g., the electronic device 101 of FIG. 1, the electronic device 201 of FIG. 2) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, the method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore^{TM}), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from this spirit and scope of the disclosure as defined by the appended claims and their equivalents.

What is claimed is:

1. An electronic device comprising:
at least one processor; and
memory storing instructions that, when executed by the at least one processor individually or collectively, cause the electronic device to:
determine, respectively, a first state of a user and a second state of the user, based on one or more of a property of first video content and first sensor data acquired while the first video content is being output,
output second video content comprising second image frames temporally positioned between first image frames of the first video content, based on a difference between the first state and the second state, and
output third video content comprising fourth image frames temporally positioned after a third image frame of the first video content, based on second sensor data acquired after the output of the second video content is initiated.

2. The electronic device of claim 1, wherein the instructions, when executed by the at least one processor individually or collectively, further cause the electronic device to:
determine the first state based on the first sensor data;
determine the second state based on the property of the first video content when the first video content is video content of a first property; and
determine the second state based on the first sensor data when the first video content is video content of a second property.

3. The electronic device of claim 1, wherein the instructions, when executed by the at least one processor individually or collectively, further cause the electronic device to:
determine a type of the second video content based on information related to the first video content; and
output the second image frames corresponding to the type of the second video content.

4. The electronic device of claim 3, wherein the instructions, when executed by the at least one processor individually or collectively, further cause the electronic device to:
determine an output timepoint of the second video content based on the type of the second video content;
generate the second image frames based on one or more of the type and the output timepoint of the second video content; and
output the second image frames after a reference image frame of the first video content corresponding to the output timepoint.

5. The electronic device of claim 4, wherein the instructions, when executed by the at least one processor individually or collectively, further cause the electronic device to:
estimate an amount of time for generating the second image frames based on the type of the second video content; and
determine the output timepoint of the second video content based on the amount of time.

6. The electronic device of claim 5,
wherein the output timepoint of the second video content comprises any one of a first output timepoint acquired by adding the amount of time to a current time and a second output timepoint after the first output timepoint, and
wherein the second output timepoint comprises an output timepoint within a specific section of the first video content positioned after the first output timepoint.

7. The electronic device of claim 4, wherein the instructions, when executed by the at least one processor individually or collectively, further cause the electronic device to:
generate the second image frames using an image frame positioned before the reference image frame when the second video content is video content of a first type; and
generate the second image frames using one or more of an image frame positioned before the reference image frame and an image frame positioned after the reference image frame, when the second video content is video content of a second type.

8. The electronic device of claim 4, wherein the instructions, when executed by the at least one processor individually or collectively, further cause the electronic device to:
output the second image frames based on third sensor data acquired within a predetermined time interval from the output timepoint.

9. The electronic device of claim 8, wherein the instructions, when executed by the at least one processor individually or collectively, further cause the electronic device to:
determine a third state of the user based on the third sensor data; and
output the second image frames in response to the third state matching a predetermined state.

10. The electronic device of claim 1, wherein the instructions, when executed by the at least one processor individually or collectively, further cause the electronic device to:
determine a fourth state of the user based on the second sensor data; and
output the third video content based on a difference between the fourth state and the second state.

11. The electronic device of claim 1, wherein the second image frames are generated using a generative model such that the first image frames are seamlessly connected to each other through the second image frames.

12. The electronic device of claim 1, wherein the fourth image frames comprise a background image different from a background image included in the third image frame.

13. The electronic device of claim 10, wherein an amount of time during which the third video content is output is determined based on a time interval during which the fourth state does not match the second state.

14. A method of operating an electronic device, the method comprising:
determining, respectively, a first state of a user and a second state of the user, based on one or more of a property of first video content and first sensor data acquired while the first video content is being output;
outputting second video content comprising second image frames temporally positioned between first image frames of the first video content, based on a difference between the first state and the second state; and
outputting third video content comprising fourth image frames temporally positioned after a third image frame of the first video content, based on second sensor data acquired after the output of the second video content is initiated.

15. The method of claim 14, wherein the determining, respectively, of the first state of the user and the second state of the user comprises:
determining the first state based on the first sensor data;
determining the second state based on the property of the first video content when the first video content is video content of a first property; and
determining the second state based on the first sensor data when the first video content is video content of a second property.

16. The method of claim 14, wherein the outputting of the second video content comprises:
determining a type of the second video content based on information related to the first video content; and
outputting the second image frames corresponding to the type of the second video content.

17. The method of claim 16, wherein the outputting of the second image frames comprises:
determining an output timepoint of the second video content based on the type of the second video content;
generating the second image frames based on one or more of the type and the output timepoint of the second video content; and
outputting the second image frames after a reference image frame of the first video content corresponding to the output timepoint.

18. The method of claim 17, wherein the determining of the output timepoint of the second video content comprises:
estimating an amount of time for generating the second image frames based on the type of the second video content; and
determining the output timepoint of the second video content based on the amount of time.

19. The method of claim 18,
wherein the output timepoint of the second video content comprises:
any one of a first output timepoint acquired by adding the amount of time to a current time and a second output timepoint after the first output timepoint, and
wherein the second output timepoint comprises:
an output timepoint within a specific section of the first video content positioned after the first output timepoint.

20. The method of claim 17, wherein the generating of the second image frames comprises:
generating the second image frames using an image frame positioned before the reference image frame when the second video content is video content of a first type; and
generating the second image frames using one or more of an image frame positioned before the reference image frame and an image frame positioned after the reference image frame, when the second video content is video content of a second type.
